(19) United States
(12) Patent Application Publication
(10) Pub. No.: US 2017/0262824 A1
(43) Pub. Date: Sep. 14, 2017

(54) Currency Exchange System and Methodology

(71) Applicant: Harpreet Singh, Jacksonville, FL (US)

(72) Inventor: Harpreet Singh, Jacksonville, FL (US)

(21) Appl. No.: 15/455,500

(22) Filed: Mar. 10, 2017

Related U.S. Application Data
(60) Provisional application No. 62/306,313, filed on Mar. 10, 2016.

(51) Int. Cl. G06Q 20/10; G06Q 20/32

(52) U.S. Cl. CPC G06Q 20/1085; G06Q 20/3278; G06Q 20/3223

(57) ABSTRACT

A method and system facilitating the dispensing of foreign currency from a foreign ATM comprising a smartphone enabled mobile app controlling and enabling the method, a foreign currency account created and controlled through the mobile app, the foreign currency account maintained by a financial institution participating in the international monetary exchange system, funds in the foreign currency app created by exchanging a home currency for a foreign currency, the mobile app able to communicate with the foreign ATM to provide secure identification and withdrawal information, the entity operating the foreign ATM able to communicate with the financial entity maintaining the foreign currency account, which is able to transfer funds to the foreign ATM operating entity to repay the foreign operating entity for foreign currency dispensed from the foreign ATM.

This application claims the benefit of U.S. Provisional Patent Application Ser. No. 62/306,313, filed on Mar. 10, 2016, the disclosure of which is incorporated herein by reference.

### BACKGROUND OF THE INVENTION

This application relates generally to the field of currency exchange systems for the exchange of one currency for the currency of another nation, and more particularly relates to such systems wherein foreign currencies are obtainable by travelers from automatic teller machines (ATM's) of participating entities.

Obtaining foreign currencies for a trip to another country may currently be accomplished through several systems. In one system the individual buys foreign currencies prior to entering the foreign country, such as at a kiosk located for example in an airport terminal. This necessitates carrying significant amounts of currency, which increases the chance of losing the currency through misplacement or theft. In addition, this option is not available once the traveler has left the airport, except at off-airport exchange entities with unlimited hours of operation. Another system involves purchasing the currency at a foreign bank upon arrival. This requires the traveler to carry large amounts of currency from the country of origin, to purchase traveler checks prior to departure, with the attached surcharge, or to utilize a credit card at the foreign bank. The transaction at the foreign bank will entail fee surcharges, possibly including credit card exchange rate fees, and will require a time expenditure. The transactions must occur during bank operating hours. Still another system involves the use of a credit card at foreign ATM's. Fee surcharges are typically added, and this system requires a physical card, which may be lost or stolen. It is also known to establish a foreign currency account in a bank in the home country, which then issues the traveler a debit card for use in the foreign ATM's. The problem with this system is that very few banks offer this option, the account must be set up well in advance of the trip, and opening the account is typically a complicated process usually requiring in person interaction with bank personnel, rendering it virtually impossible for individuals living in areas not services by a particular offering bank.

It is an object to provide a currency exchange system that addresses the problems associated with the known systems, wherein the system involves the use of a mobile app defining a virtual debit card, the transactions being accomplished via near frequency communication (NFC) between the user's smartphone and a foreign ATM. The traveler is able to immediately establish a foreign currency account through the mobile app and is able to immediately withdraw foreign currency form a foreign ATM.

The system eliminates time constraints and location limitations for the establishment of a foreign currency account for the exchange of currency, provides a secure exchange process while reducing the risk of needing to carry large sums. The system will also enable the user to carry out exchanges in multiple currencies, provide a means for payment of point of sale purchases with a virtual debit card instead of a credit card, allow the user to deposit surplus currency into a local ATM for credit back into the user's foreign currency account, eliminate the need for an actual debit/credit card, provide a lower rate of transaction fees than possible through brick-and-mortar systems, provide an SSL secured website and mobile platform, and/or be compliant with regulations concerning privacy, money laundering, the Patriot Act and the Intelligence Reform & Terrorism Prevention Act of 2004.

### SUMMARY

The invention is in various embodiments a system and methodology for facilitating the dispensing of foreign currency from a foreign ATM that provides an alternative to known systems for obtaining foreign currencies. In general, the system comprises the steps of developing software and providing a mobile application (“app”) downloadable to a smartphone that enables a user to open or create a foreign currency account linked to the user's home source account, such as for example a personal bank checking account or a credit card. The user electronically transfers (i.e., “deposits”) funds from the home account to the foreign currency account and designates (i.e., “purchases”) one or more foreign currencies in desired amounts at the exchange rate in effect at the time of designation. When the user is in the foreign country and desires cash in the foreign currency, the user proceeds to any member ATM and enters the required identification through wireless electronic communication, for example via near frequency communication (NFC) to withdraw funds from the ATM in the foreign currency. The user is able to transfer additional funds from the home account to the foreign currency account as needed anywhere cell service or Wi-Fi is available, even while abroad. The user is also able to deposit foreign currency into the foreign currency account prior to leaving the foreign country. In this manner, the user establishes a “virtual” foreign currency account via the mobile app without need for direct contact with a bank or other financial institution maintaining the account.

In alternative terms, the invention is a method of facilitating the dispensing of foreign currency from a foreign ATM to a user traveling in the foreign country, comprising the steps of providing a mobile app to the user accessible by a smartphone, said user having a home source account, said mobile app controlled by a server and in electronic communication with a financial institution maintaining foreign currency accounts, said mobile app enabling said user to create a personal foreign currency account in a designated foreign currency and to transfer funds from said home source account through said mobile app into said foreign currency account, said funds from said home source account being exchanged for said designated foreign currency at the existing exchange rate; said user creating through said mobile app said personal foreign currency account in said designated foreign currency and transferring funds from said home source account through said mobile app into said foreign currency account, said funds from said home source account being exchanged for said designated foreign currency at the existing exchange rate; said user inputting through said mobile app secure information to said foreign ATM and requesting an amount of foreign funds to be dispensed by said foreign ATM, said mobile app being adapted to communicate electronically with said foreign ATM, said foreign funds being dispensed from said foreign ATM to said user only after the identity of said user has been verified and the presence of sufficient funds in said foreign currency account has been verified by communication between said foreign ATM operating entity and financial institution maintaining said foreign currency account, said financial institution subsequently transferring funds from said foreign currency account to said foreign ATM operating entity in equal or greater amount to the foreign funds dispensed by said foreign ATM to said user. The method may further comprise the method wherein said mobile app communicates with said foreign ATM by near frequency communication, and/or the method with said user creating said personal foreign currency account in a first designated foreign currency and creating a second personal foreign currency account in a second designated foreign currency, such that funds are distributed by a foreign ATM in said first designated foreign currency in a first foreign country and funds are distributed by a foreign ATM in said second designated foreign currency in a second foreign country.

Alternatively, the invention is a system facilitating the dispensing of foreign currency from a foreign ATM to a user travelling in the foreign country, comprising a smartphone and a smartphone enabled mobile app, said mobile app in electronic communication with a financial institution maintaining foreign currency accounts, said mobile app enabling said user to establish a personal foreign currency account in said financial institution, transfer funds from a personal home source account to said foreign currency account, said funds being maintained in said foreign currency account in a designated foreign currency, the amount of said designated foreign currency being determined by the exchange rate at the time of transfer of said funds from said personal home account; an international monetary exchange system providing verification protocols and enabling electronic transfer of funds between said foreign currency account and a financial institution operating a foreign ATM; a foreign ATM dispensing funds in said designated foreign currency, said foreign ATM in communication with said smartphone enabled mobile app; whereby said user is able to withdraw funds from said personal foreign currency account through said foreign ATM via communication from said smartphone enabled mobile app.

### BRIEF DESCRIPTION OF THE DRAWINGS

FIG. 1 is a flow chart illustrating the main points of the system and method.

FIG. 2 is an overview schematic of the system architecture and main functionalities of the mobile app.

FIGS. 3 is an overview schematic of the system architecture and main functionalities of the mobile app with personal foreign currency accounts set up in multiple currencies.

### DETAILED DESCRIPTION OF THE INVENTION

In general, the invention is a system and methodology in various embodiments that provides an alternative to known systems for obtaining foreign currencies in a foreign country. As used herein, the term “home” shall be used to refer to the home country of the user and will be illustrated herein as the United States, and the term “foreign” shall refer to a non-home country in which the user is travelling and desires to obtain currency of that country from an ATM.

In general, the invention is an interconnected system of Internet-enabled hardware components and interconnected financial entities comprising servers and interconnected communication systems, the system including in this instance enabled and controlled by a mobile software application downloaded onto or accessible from a smartphone or similar portable computing device, that facilitates the dispensing of foreign funds from an ATM. The system and method provides an infrastructure to enable communication between currency exchange system servers and other system components that communicate between member financial institutions in different countries, ATM's in foreign countries, and multiple traveling individuals, as well as initiation and administration of various currency accounts. The system incorporates a mobile application (“app”) in communication with an operational server that enables a user to create a virtual personal foreign currency account in a bank or similar financial institution, participating in the international monetary exchange system, whether one having actual physical facilities or an Internet bank, with the personal foreign currency account linked to the user's personal source account, such as a bank checking account or credit card in the user's home country. The foreign currency account is controlled and accessed by the user through the smartphone app. Necessary information for the home account, such as for example routing number, account number, account type, SWIFT codes, etc., is inputted into the mobile app by the user during initial set-up.

The user via the mobile app electronically transfers (i.e., “deposits”) funds from the home source account to the virtual personal foreign currency account and designates (i.e., “purchases”) one or more foreign currencies in desired amounts. The purchase of foreign currencies is accomplished at the existing exchange rate, such that the funds maintained in the foreign exchange account are in the foreign denomination. For example, a user intending to travel from the US to the UK may decide to designate US$6000 from the home source account to purchase the equivalent value at the time of purchase in British Pounds (GBP). At an exchange rate of 1 GBP=1.5 US$, the foreign currency account is therefore credited with GBP4000 and the US$6000 is deducted from the home source account.

When the user is in the foreign country and desires cash in the foreign currency, in this example GBP, the user proceeds to any ATM participating in the system to withdraw funds in the foreign currency, such as for example GBP200. The user enters the required identification and security information, preferably through wireless electronic communication with the user's smartphone, such as by near field communication (NFC) technology. The financial entity operating or participating through the foreign ATM, such as for example a bank, internet bank, credit companies such as Visa or MasterCard, PayPal, Apple Pay, Google Wallet, etc., verifies the requestor identity and verifies that the requestor has sufficient funds in the foreign currency account to cover the desired withdrawal of funds through normal interbank communications. The foreign ATM dispenses GBP200 to the user and the currency exchange system server then credits to the foreign ATM operating entity GBP200. In actuality a service or transfer fee or surcharge will be added to the amount credited to the foreign operating entity, such as for example a transfer fee of GBP5 as compensation to the ATM operating entity, such that a total for GBP205 is transferred and the foreign currency account now contains GBP3795 (GBP4000 less GBP205).

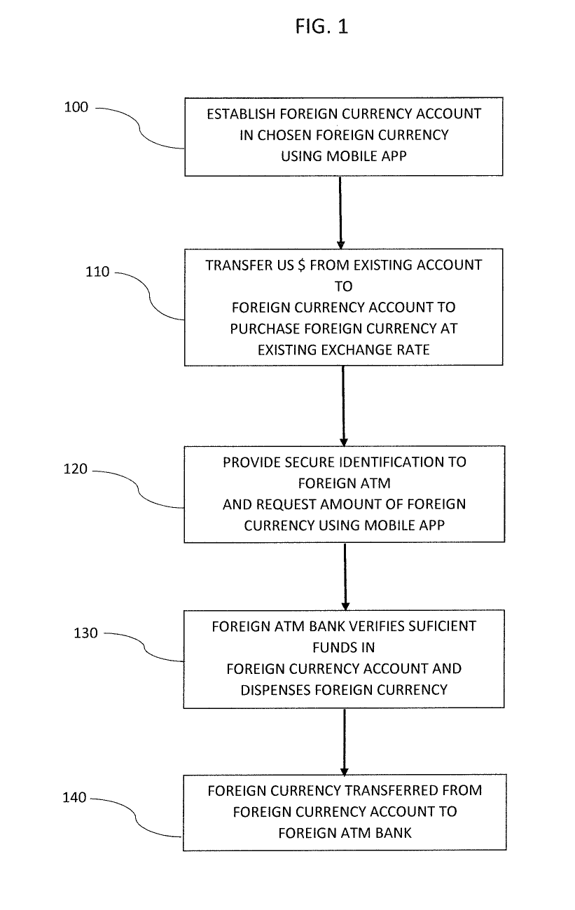

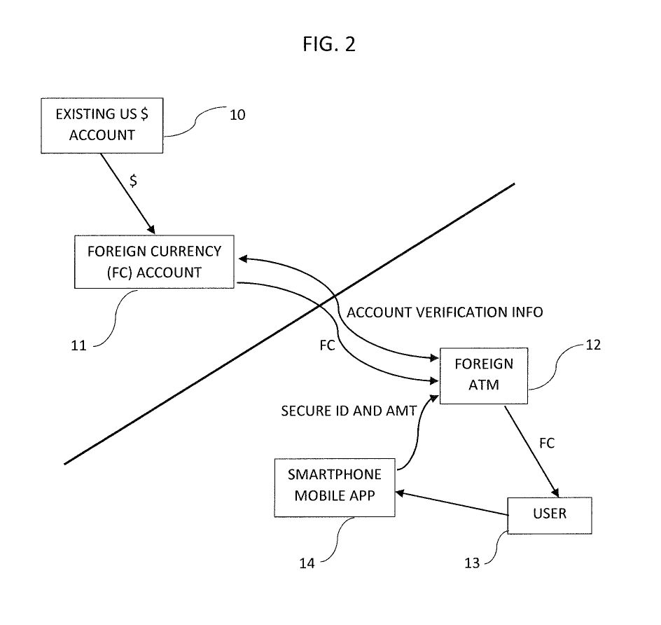

FIG. 1 illustrates the methodology steps of the system and FIG. 2 illustrates the architecture of the system. In step 100, the user or future traveler 13 establishes, through the mobile app 14 on a smartphone or similar portable computing device, a virtual personal foreign currency account 11 in one or more designated foreign currencies. The foreign currency account 11 is linked via the mobile app 14 to an existing home source account 10, in this case an account in US dollars. In step 110 the user 13 electronically transfers an amount of US dollars to the virtual foreign currency account 11, designating at the time the foreign currency which is to be purchased. The amount of designated foreign currency purchased by the user 13 is then credited to the foreign currency account 11, i.e., the foreign currency account 11 contains funds only in the designated foreign denomination.

When the user 13 travels to a country utilizing the foreign currency contained in the foreign currency account 11 and desires to acquire actual foreign currency from a foreign ATM 12 adapted to communicate with the smart phone mobile app 14 through NFC or the like, the user 13 delivers the account identification information and the necessary secure identification information, such as for example personal identification numbers (PIN's) of passcodes, to the foreign ATM 12 operating entity, as shown in step 120. Alternatively, the system may allow the user 13 to input the account identification information and the necessary secure identification information into the foreign ATM 12 via the ATM keypad.

In step 130, the operating entity of the foreign ATM 12, such as a foreign bank, then communicates through the standard international monetary transfer system with the bank entity maintaining the foreign currency account 11 of the user 13 to verify the user's identity, verify the existence of a foreign currency account 11 in the appropriate foreign currency, and verify that the foreign currency account 11 contains sufficient funds to cover the amount of foreign currency (FC) to be provided to the user 13. If all verifications are obtained, the foreign ATM 12 then dispenses the funds to the user 13.

As shown in step 140, the bank entity maintaining the foreign currency account 11 then electronically transfers the appropriate amount of foreign funds to the entity operating the foreign ATM 12, plus any surcharges or fees, deducting the full amount of foreign funds from the foreign currency account 11, through standard electronic international monetary exchange protocols.

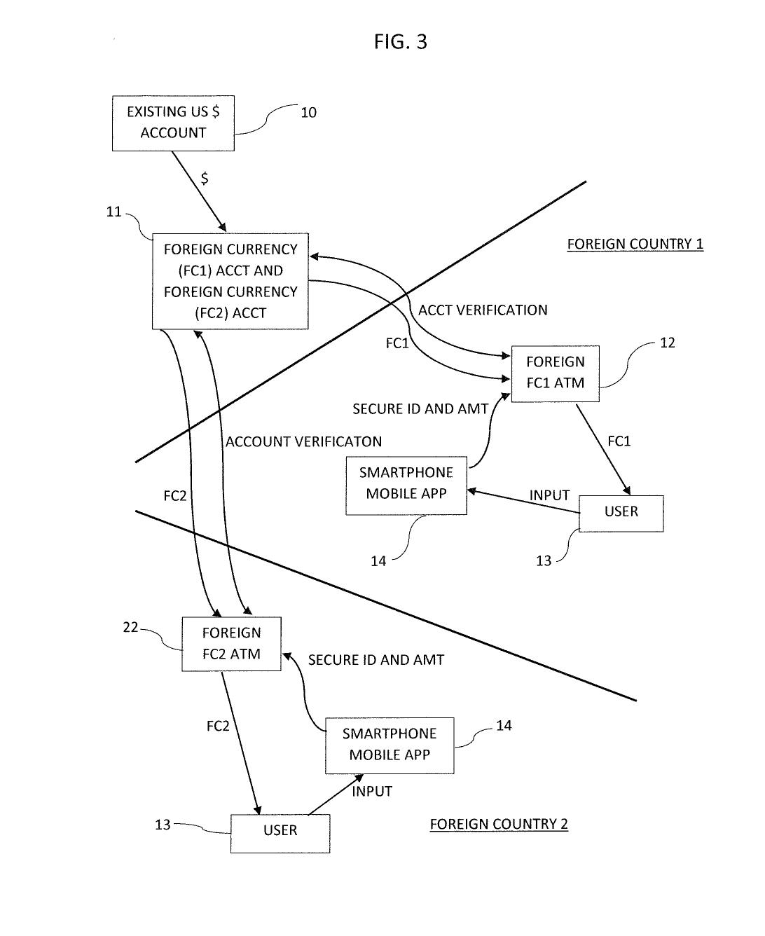

FIG. 3 illustrates a situation wherein a user 13 establishes two foreign currency accounts 10 via the mobile app 14, the first foreign currency designated as FC1 and the second different foreign currency designated as FC2. In this example, when the user 13 is in the first foreign country, the foreign ATM 12 will dispense foreign currency FC1 to the user 13. When the user 13 is in the second foreign country, the foreign ATM 22 will dispense foreign currency FC2 to the user 13. In all other respects the methodology remains the same.

A key advantage to this system is that there are no ongoing exchange rate issues no matter when or how often the user obtains the foreign currency, since the virtual foreign currency account possesses the foreign currency amount determined at the exchange rate at the time of designation into the foreign currency account.

In a second example, the user may create multiple foreign currency accounts and designate multiple associated foreign currencies. For example, the user may designate one amount of US dollars for GBP and another amount of US dollars for Euros, the foreign currency accounts being maintained separately in the system. The user can then withdraw GBP while in the UK and Euros while in mainland Europe. The foreign currencies are segregated, meaning that transfers cannot be effected from one foreign currency to another, such as Euros for GBP.

The user is able through the smartphone mobile app to transfer additional funds from the home source account to the foreign currency account as needed even while abroad. The user is also able to deposit foreign currency back into the foreign currency account prior to leaving the foreign country, such that the foreign currency is credited into the foreign currency account and can later be converted into US dollars for withdrawal in the home country if desired.

The currency exchange system and app may provide multi-functionality in addition to the basic account management functions of initial sign-up and subsequent log-in and currency transfer. The mobile app may also preferably provide an ATM locator (via GPS, GPRS or Wi-Fi), means to contact the system operators and means to provide feedback.

Furthermore, in additional embodiments the system and methodology may be utilized to obtain foreign currency by direct interaction with foreign bank personnel or to obtain goods or services via point-of-sale (POS) systems.

It is understood and contemplated that substitutions and equivalents for certain steps, elements, architectural components and the like described above may be obvious to those with skill in the art, and therefore the true scope and definition of the invention is to be as set forth in the following claims.

I claim:

1. A method of facilitating the dispensing of foreign currency from a foreign ATM to a user traveling in the foreign country, comprising the steps of:
providing a mobile app to the user accessible by a smartphone, said user having a home source account, said mobile app controlled by a server and in electronic communication with a financial institution maintaining foreign currency accounts, said mobile app enabling said user to create a personal foreign currency account in a designated foreign currency and to transfer funds from said home source account through said mobile app into said foreign currency account, said funds from said home source account being exchanged for said designated foreign currency at the existing exchange rate;
said user creating through said mobile app said personal foreign currency account in said designated foreign currency and transferring funds from said home source account through said mobile app into said foreign currency account, said funds from said home source account being exchanged for said designated foreign currency at the existing exchange rate;
said user inputting through said mobile app secure information to said foreign ATM and requesting an amount of foreign funds to be dispensed by said foreign ATM, said mobile app being adapted to communicate electronically with said foreign ATM, said foreign funds being dispensed from said foreign ATM to said user only after the identity of said user has been verified and the presence of sufficient funds in said foreign currency account has been verified by communication between said foreign ATM operating entity and financial institution maintaining said foreign currency account, said financial institution subsequently transferring funds from said foreign currency account to said foreign ATM operating entity in equal or greater amount to the foreign funds dispensed by said foreign ATM to said user.

2. The method of claim 1, wherein said mobile app communicates with said foreign ATM by near frequency communication.

3. The method of claim 1, said user creating said personal foreign currency account in a first designated foreign currency and creating a second personal foreign currency account in a second designated foreign currency, such that funds are distributed by a foreign ATM in said first designated foreign currency in a first foreign country and funds are distributed by a foreign ATM in said second designated foreign currency in a second foreign country.

4. A system facilitating the dispensing of foreign currency from a foreign ATM to a user travelling in the foreign country, comprising:
a smartphone and a smartphone enabled mobile app, said mobile app in electronic communication with a financial institution maintaining foreign currency accounts, said mobile app enabling said user to establish a personal foreign currency account in said financial institution, transfer funds from a personal home source account to said foreign currency account, said funds being maintained in said foreign currency account in a designated foreign currency, the amount of said designated foreign currency being determined by the exchange rate at the time of transfer of said funds from said personal home account;
an international monetary exchange system providing verification protocols and enabling electronic transfer of funds between said foreign currency account and a financial institution operating a foreign ATM;
a foreign ATM dispensing funds in said designated foreign currency, said foreign ATM in communication with said smartphone enabled mobile app;
whereby said user is able to withdraw funds from said personal foreign currency account through said foreign ATM via communication from said smartphone enabled mobile app.
